(19) United States
(12) Patent Application Publication
(10) Pub. No.: US 2006/0159854 A1
(43) Pub. Date: Jul. 20, 2006

(54) Method for forming inorganic thin film on polyimide resin and method for producing polyimide resin having reformed surface for forming inorganic thin film

(75) Inventors: Hiroshi Yanagimoto, Ashiya-shi (JP); Hidemi Nawafune, Takatsuki-shi (JP); Kensuke Akamatsu, Nagaokakyo-shi (JP)

Correspondence Address: SUGHRUE MION, PLLC, 2100 PENNSYLVANIA AVENUE, N.W., SUITE 800, WASHINGTON, DC, 20037, US

(73) Assignee: MITSUBOSHI BELTING LTD.

(21) Appl. No.: 11/296,228

(22) Filed: Dec. 8, 2005

(30) Foreign Application Priority Data
Dec. 8, 2004 (JP) P.2004-355761

(51) Int. Cl. B05D 1/40; B05D 5/00; B05D 1/36; B05D 5/12

(52) U.S. Cl. 427/331; 427/258; 427/96.1; 427/402

(57) ABSTRACT

The present invention provides a method for forming an inorganic thin film on a polyimide resin, which includes: (1) a step of applying an alkaline aqueous solution on a polyimide resin at the site where an inorganic thin film is formed to cleave an imide ring of the polyimide resin so as to produce a carboxyl group and to reform the polyimide resin to a polyamic acid whereby a reformed portion including the polyamic acid having the carboxyl group is formed; (2) a step of contacting a solvent in which the polyamic acid is soluble to the reformed portion to remove a part of the reformed portion so as to form a concave part; (3) a step of contacting a solution containing a metal ion to the reformed portion, which is near the concave part, so as to produce a metal salt of the carboxyl group; and (4) a step of separating the metal salt as a metal, a metal oxide or a semiconductor on the surface of the polyimide resin so as to form the inorganic thin film.

### FIELD OF THE INVENTION

The present invention relates to a method where an inorganic thin film is formed on a surface of a polyimide resin in a fine pattern such as a circuit pattern.

### BACKGROUND OF THE INVENTION

Various methods have been proposed for a method of forming a circuit pattern on the surface of a base material made by polyimide resin such as polyimide film. Among them, a dry process such as vacuum evaporation method and sputtering method have been known as a method which is able to well form a fine circuit pattern having an excellent reliability for close adhesion. However, there is a problem that such a method requires an expensive apparatus and, moreover, it has a low productivity and results in a high cost.

Therefore, as a most common method for forming a circuit pattern, a subtractive method where the whole surface of the polyimide resin base material is coated with a metal film to prepare a metal-coated material and a metal film at the unnecessary site is removed by a photolithographic method by means of an etching treatment has been widely adopted at present. A adhesive force between the polyimide resin base material and the metal film in the metal-coated material is ensured by an anchor effect where the base material surface is made rough or by an adhesive. Although this subtractive method has an excellent productivity and is useful as a method for forming a circuit pattern relatively easily, many metal films are to be removed in the preparation of a circuit pattern and, therefore, there is a problem that much useless metal material is generated. In addition, there has been a demand in recent years for much finer circuit pattern as a result of trend of high density of the electronic circuit substrate but, in a subtractive method, there is another problem that, due to generation of over-etching and to the presence of adhesive or unevenness by roughening of the substrate surface, it is difficult to meet the request for formation of a fine circuit pattern.

In view of the above, there have been brisk studies for methods for circuit pattern formation as a substitute for a subtractive method. For example, an additive method which is a kind of a photolithographic method is a method where the site other than the circuit forming site on the substrate surface is coated with a mask such as a photosetting resin and a circuit pattern is directly formed on the substrate surface using non-electrolytic plating. The non-electrolytic method is a method where oxidation-reduction reaction in a solution is utilized and metal film is formed on the substrate surface to which plated catalyst nuclei are given. As compared with the aforementioned dry process, this additive method has an excellent productivity and, as compared with a subtractive method, it is able to form fine circuit pattern. However, since it is difficult to ensure the adhesive force between the polyimide resin base material and the metal film, there is a problem of inferior reliability for close adhesion. There is another problem in the additive method that its steps are complicated and an expensive production facility is necessary for formation of fine circuit pattern resulting in a high cost.

Further, as a method where fine circuit is formed easily and at low cost, an ink jet method has been receiving public attention. In the ink jet method, ink constituted from metal nano-particles is sprayed onto the substrate surface in a pattern form from an ink jet nozzle and, after applying, it is subjected to an annealing treatment to form a circuit pattern comprising a fine metal film. However, when metal nano-particle numbers per unit area of the substrate surface are insufficient in spraying and applying of the metal nano-particles by an ink jet system, there is a possibility that the resulting metal film is broken due to shrinking as a result of sintering among the metal nano-particles upon annealing, while when metal nano-particle numbers are in excess, there is a possibility that flatness and smoothness of the metal film formed after the annealing are lost whereby there is a problem that control of applying amount of the metal nano-particles on the substrate is very severe. In addition, due to their properties, metal component of metal nano-particles and substrate are hardly difficult to achieve a sufficient reliability for close adhesion. Further, there is another problem in precision of the size due to shrinking as a result of sintering among nano-particles upon annealing.

In recent years, there has been proposed an art as an art of formation of a circuit pattern having an excellent reliability for close adhesion where a surface of polyimide resin base material is treated with an aqueous alkali solution to form carboxyl groups, metal ions are coordinated to said carboxyl groups to form metal salts of the carboxyl groups, ultraviolet ray is irradiated onto said polyimide resin base material via a photomask so that the metal ions is selectively reduced to form a metal film and, if necessary, the metal film is made thick by a plating method (e.g., Reference 1). In the metal film formed by that method, a part of it is embedded in the polyimide resin whereby a reliability of close adhesion of the metal film to the polyimide resin substrate surface is able to be highly achieved.

[Reference 1] JP 2001-73159 A

However, in a method for forming a pattern by irradiation of ultraviolet ray via a photomask as in Reference 1, it is difficult to cope with a very fine circuit pattern being demanded as the trend of high density of the circuit substrate. In addition, thickness of the resulting metal film on a level of nm, thickening of the film is necessary in most of the uses for circuit pattern. Thus, it is necessary that a metal film is separated out by a plating method on the circuit pattern of the resulted metal film. However, in a plating method, metal film is separated out in an isotropic manner and, therefore, there is a risk that precision of the pattern is deteriorated after the thickening and, at the same time, reliability for close adhesion lowers. In order to solve such a problem, there is a proposal, for example, where a high-molecular film is formed on the substrate surface which is other than the site where a circuit pattern is formed and then thickening is conducted by a plating method but there is a problem that steps become complicated resulting in a high cost.

### SUMMARY OF THE INVENTION

The present invention has been achieved in view of the above-mentioned circumstances and an object of the present invention is to provide a method for forming an inorganic thin film on a polyimide resin whereby an inorganic thin film is able to be formed on the surface of a polyimide resin with high reliability for close adhesion and high pattern precision and also to provide a method for producing a polyimide resin having a reformed surface for forming an inorganic thin film.

The present inventors have made eager investigation to examine the problem. As a result, it has been found that the foregoing objects can be achieved by the following methods. With this finding, the present invention is accomplished.

The present invention is mainly directed to the following items:

1. A method for forming an inorganic thin film on a polyimide resin, which comprises: (1) a step of applying an alkaline aqueous solution on a polyimide resin at the site where an inorganic thin film is formed to cleave an imide ring of the polyimide resin so as to produce a carboxyl group and to reform the polyimide resin to a polyamic acid whereby a reformed portion comprising the polyamic acid having the carboxyl group is formed; (2) a step of contacting a solvent in which the polyamic acid is soluble to the reformed portion to remove a part of the reformed portion so as to form a concave part; (3) a step of contacting a solution containing a metal ion to the reformed portion near the concave part so as to produce a metal salt of the carboxyl group; and (4) a step of separating the metal salt as a metal, a metal oxide or a semiconductor on the surface of the polyimide resin so as to form the inorganic thin film.

According to the above invention of item 1, a concave part is formed on the polyimide resin at the site where an inorganic thin film is formed, and it is possible to form a metal, a metal oxide or a semiconductor on the inner surface of the concave part whereby an inorganic thin film is formed. Thus, an inorganic thin film is able to be formed in a concave part and the inorganic thin film is able to be formed with a high reliability for close adhesion and with a high pattern precision.

2. The method for forming an inorganic thin film on a polyimide resin according to item 1, wherein the solvent in which the polyamic acid is soluble is a solvent having an amide group.

According to the above invention of item 2, a concave part is able to be easily formed in the step (2).

3. The method for forming an inorganic thin film on a polyimide resin according to item 1, wherein, in the step (1), the alkaline aqueous solution is applied on a polyimide resin at the site where an inorganic thin film is formed by an ink jet method.

According to the above invention of item 3, an alkaline aqueous solution is able to be applied in a fine pattern using an ink jet method and an inorganic thin film is able to be formed finely with a high pattern precision.

4. The method for forming an inorganic thin film on a polyimide resin according to item 1, wherein, in the step (1), the alkaline aqueous solution is applied on a polyimide resin at the site where an inorganic thin film is formed by a transfer method.

According to the above invention of item 4, an alkaline aqueous solution is able to be applied in a fine pattern using a transfer method and an inorganic thin film is able to be formed finely with a high pattern precision.

5. The method for forming an inorganic thin film on a polyimide resin according to item 1, wherein, in the step (1), an alkali-resistant protective layer is formed on a polyimide resin at the part other than the site where an inorganic thin film is formed before applying the alkaline aqueous solution on the polyimide resin.

According to the above invention of item 5, an alkaline aqueous solution is able to be applied only to the desired site where an inorganic thin film is formed and an inorganic thin film is able to be formed in a desired pattern.

6. The method for forming an inorganic thin film on a polyimide resin according to item 1, wherein, in the step (4), the metal salt is subjected to a reducing treatment to be separated as a metal on a surface of the polyimide resin so as to form a metal thin film.

According to the above invention of item 6, a metal thin film is able to be formed at the site where an inorganic thin film is formed and, as a result of formation of a circuit pattern by a metal thin film, the product is able to be used as an electronic circuit substrate or the like where polyimide resin is a base material.

7. The method for forming an inorganic thin film on a polyimide resin according to item 1, wherein, in the step (4), the metal salt is reacted with an activated gas to be separated as a metal oxide or a semiconductor on a surface of the polyimide resin so as to form a metal oxide thin film or a semiconductor thin film.

According to the above invention of item 7, a metal oxide thin film or a semiconductor thin film is able to be formed at the site where an inorganic thin film is formed and that is able to be used as various electronic parts having a metal oxide thin film or a semiconductor thin film.

8. The method for forming an inorganic thin film on a polyimide resin according to item 1, wherein, in the step (4), the inorganic thin film comprises an aggregate of inorganic nano-particles.

According to the above invention of item 8, a close adhesion strength of the inorganic thin film is able to be enhanced utilizing an anchor-locking effect of the aggregate of inorganic nano-particles and, at the same time, a non-electrolytic plating is able to be easily carried out on the surface of the inorganic thin film utilizing the catalytic activity of the aggregate of the inorganic nano-particles.

9. The method for forming an inorganic thin film on a polyimide resin according to item 8, wherein, in the step (4), a part of the aggregate of inorganic nano-particles is embedded in the polyimide resin.

According to the above invention of item 9, an inorganic thin film comprising an aggregate of inorganic nano-particles is able to be closely adhered to a polyimide strongly due to a high anchor locking effect to the aggregate of the inorganic nano-particles to the polyimide resin.

10. The method for forming an inorganic thin film on a polyimide resin according to item 1, which further comprises, after the step (4), (5) a step of subjecting to a non-electrolytic plating on the surface of the polyimide resin on which the inorganic thin film is separated.

11. The method for forming an inorganic thin film on a polyimide resin according to item 8, which further comprises, after the step (4), (5) a step of subjecting to a non-electrolytic plating on the surface of the polyimide resin on which the inorganic thin film is separated.

According to the above inventions of item 10 and 11, a non-electrolytically plated film is thickened on the surface of an inorganic thin film to make the thickness of the inorganic thin film thick and circuit of the electronic circuit substrate is able to be formed by the inorganic thin film.

12. The method for forming an inorganic thin film on a polyimide resin according to item 11, wherein, in the step (5), the non-electrolytic plating is carried out by using the aggregate of the inorganic nano-particles as a nucleus for separation of plating.

According to the above invention of item 12, a non-electrical plating is separated on the surface of the inorganic thin film comprising an aggregate of inorganic nano-particles whereby a non-electric plating is able to be conducted selectively on the surface of the inorganic thin film and the non-electrolytically plated film is produced in the inner area of the concave where the inorganic thin film is formed whereby, in thickening the inorganic thin film with the non-electrolytically plated film, pattern precision is able to be maintained even after the thickening.

13. The method for forming an inorganic thin film on a polyimide resin according to item 1, wherein the inorganic thin film has a shape of a circuit pattern.

According to the above invention of item 13, a circuit is able to be formed by the inorganic thin film formed at the site where the inorganic thin film is formed and that is able to be used as an electronic circuit substrate where polyimide resin is a base material.

14. A method for producing a polyimide resin having a reformed surface for forming an inorganic thin film, which comprises: applying an alkaline aqueous solution on a part of a polyimide resin to cleave an imide ring of the polyimide resin so as to produce a carboxyl group and to reform the polyimide resin to a polyamic acid whereby a reformed portion comprising the polyamic acid having the carboxyl group is formed; and contacting a solvent in which the polyamic acid is soluble to the reformed portion to remove a part of the reformed portion so as to form a concave part in such a state that a part of the reformed portion remains.

According to the above invention of item 14, a concave part is able to be formed at the area where an alkaline aqueous solution is applied to the surface of the polyimide resin, and a reformed portion where carboxyl group is formed is able to be formed on the inner surface of the concave part whereby it is able to be used as a base material for forming an inorganic thin film in the concave part.

In accordance with the present invention, a concave part is formed at the site of a polyimide resin where an inorganic thin film is formed, and it is possible to form an inorganic thin film on the inner surface of the concave part by separation of metal or metal oxide or semiconductor whereby formation of the inorganic thin film is able to be done in the concave part, and the inorganic thin film is able to be formed with a high reliability for close adhesion and with a high pattern precision.

### BRIEF DESCRIPTION OF THE DRAWINGS

FIG. 1A to 1G shows an example of the embodiment of the present invention, and each is a schematic cross-sectional view.

The reference numerals used in the drawings denote the followings, respectively.

1: polyimide resin base material

2: alkaline aqueous solution

3: concave part

4: reformed portion

5: reformed portion containing metal ion

6: inorganic thin film

7: non-electrolytically plated film

### DETAILED DESCRIPTION OF THE INVENTION

Hereinafter, the present invention will be described in detail.

Polyimide resin is a polymer having a cyclic imide structure in the main chain being produced, for example, by imidation of polyamic acid and is a thermosetting resin having excellent heat resistance, resistance to chemicals, mechanical strength, resistance to flame, electric insulation, etc. In the present invention, film, molded plate or the like of the polyimide resin can be used as base materials and there is no particular limitation for its shape.

Firstly, in the step (1) of the present invention, an alkaline aqueous solution is applied on the surface of a base material of the polyimide resin. There is no particular limitation for the alkaline aqueous solution and examples thereof include aqueous solution of potassium hydroxide, aqueous solution of sodium hydroxide, aqueous solution of calcium hydroxide, aqueous solution of magnesium hydroxide and aqueous solution of ethylenediamine. Although there is no particular limitation for the concentration of the alkaline aqueous solution, it is preferably 0.01 to 10 M and, more preferably 0.5 to 6 M. An auxiliary agent selected from binder resin, organic solvent, inorganic filter, thickener, leveling agent, etc. may be added to the alkaline aqueous solution to control viscosity, wetting property to the polyimide resin base material, flatness/smoothness and volatility. That is preferred to be selected depending upon shape, line width, etc. of the applied pattern.

Application of the alkaline aqueous solution to the polyimide resin base material in the present invention is selectively done only to the site where an inorganic thin film is formed. When the alkaline aqueous solution is applied to the surface of the polyimide resin base material, an amide bond (—CONH—) with a carboxyl group (—COOA; alkali metal salt or alkali earth metal salt of carboxylic acid) is formed as a result of cleavage of an imide ring in the molecular structure of the polyimide resin as shown in the chemical reaction formula (I) shown below as mentioned in Reference 1. Thus, when an alkaline aqueous solution is applied to the polyimide resin base material, the polyimide resin to which the alkaline solution is applied is able to be reformed to polyamic acid.

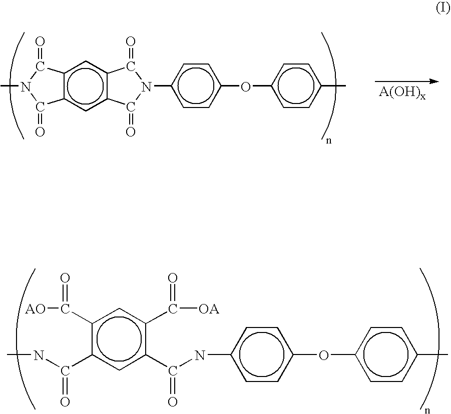

wherein A represents an alkaline metal or an alkaline earth metal.

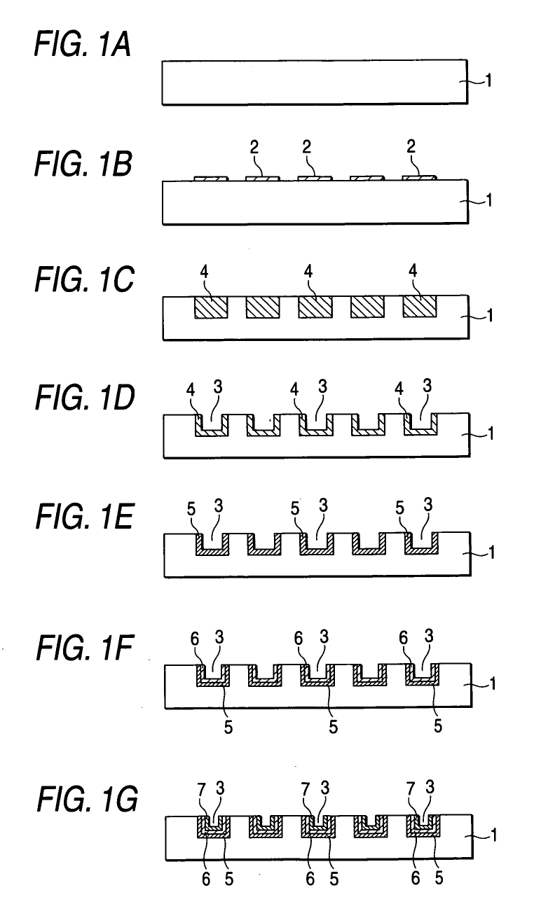

Therefore, an alkaline aqueous solution 2 is partially applied on the surface of a polyimide resin base material 1 as in FIG. 1A, and the alkaline aqueous solution 2 is selectively contacted to the site where an inorganic thin film is formed on the surface of the polyimide resin base material 1 as in FIG. 1B whereby carboxyl group is formed on the surface layer of the polyimide resin base material 1 and, at the same time, a reformed portion 4 where polyimide resin is reformed to polyamic acid is formed in a pattern along the site where the inorganic thin film is formed.

As the alkaline aqueous solution 2 partially applied on the polyimide resin base material 1 as mentioned above permeates into the surface of the polyimide resin base material 1, a reaction where carboxyl group is produced and polyimide resin is reformed to polyamic acid proceeds. Therefore, when the time for being allowed to stand after application of the alkaline aqueous solution 2 is made long and when the polyimide resin base material 1 is subjected to a heating treatment, thickness of the reformed portion 4 is able to be made large as shown in FIG. 1C. The treating temperature for applying the alkaline aqueous solution 2 to the polyimide resin base material 1 is preferably 10 to 80° C. and, more preferably 15 to 60° C. Treating time is preferably 5 to 1,800 second and, more preferably 30 to 600 seconds. To be more specific, after the alkaline aqueous solution 2 is applied on the surface of the polyimide resin base material 1, the polyimide resin substrate 1 is allowed to stand for long time together with heating whereupon it is possible to form far thicker reformed.

In a selective application of the alkaline aqueous solution to the site of the polyimide resin base material in which an inorganic thin film is formed as mentioned above, it may be carried out by, for example, an ink jet method. Thus, when the alkaline aqueous solution is used as an ink for an ink jet printer and the aqueous alkaline solution is sprayed and applied on the surface of the polyimide resin base material in a desired pattern, the alkaline aqueous solution is able to be selectively applied on the site where an inorganic thin film is formed. With regard to the ink jet printer, any of a thermal system and a piezo system can be used.

It is also possible to selectively apply the alkaline aqueous solution to the polyimide resin base material at the site where the inorganic thin film is formed by a transfer method. There is no particular limitation for the transfer method and, for example, an electronic photograph method, an offset printing method, etc. may be used. An electronic photograph method is that, for example, alkaline aqueous solution is enclosed in a thermoplastic resin capsule using a known micro-capsulating method and, at the same time, powder formed by coating of the surface of said microcapsule particles with an antistatic agent such as an azo-type metal-containing complex is used as a toner. Particle size of the powder is preferably 0.1 to 10 μm and, more preferably 0.5 to 5 μm.

It is further possible that, after an alkali-resisting protective layer is formed on a site of the surface of the polyimide resin base material which is other than the site to which an inorganic thin film is formed, an alkaline aqueous solution is applied thereto whereby the alkaline aqueous solution is selectively applied to the polyimide resin base material at the site where the inorganic thin film is formed. The alkali-resisting protective layer can be formed on the surface of the polyimide resin base material by, for example, a photolithographic method, a screen printing method or a vapor-deposition method. After the alkali-resisting protective layer is formed on the polyimide resin base material at the site which is other than the site where the inorganic thin film is formed, the alkaline aqueous solution is applied on the surface of the polyimide resin base material by a spin-coating method, a dipping method, etc. whereby the alkaline aqueous solution is able to be selectively applied only to the site where an inorganic thin film is formed which is not in a state of being coated with the alkali-resisting protective layer but in an exposed state.

In the case of formation of an alkali-resisting protective layer by a vapor deposition method, it is possible to form the alkali-resisting protective layer using a metal thin film containing at least one selected from gold, silver, aluminum, iron, tin, copper, titanium, nickel, tungsten, tantalum, cobalt, zinc, chromium and manganese. In the case of formation of an alkali-resisting protective layer by a screen printing method, it is possible to form the alkali-resisting protective layer by printing of a liquid resin containing at least one selected from acrylic resin, silicon resin and fluorine resin. In the case of formation of an alkali-resisting protective layer by a photolithographic method, it is possible to form the alkali-resisting protective layer using, for example, a fluorine resin for lithographic resist.

As mentioned above, in the step (1), an alkaline aqueous solution 2 is applied on the polyimide resin base material 1 at the site where an inorganic thin film is formed to cleave an imide ring of the polyimide resin so as to produce a carboxyl group and to reform the polyimide resin to a polyamic acid whereby a reformed portion 4 is formed and, after that, in the step (2), a solvent in which polyamic acid is soluble is contacted to the surface of the polyimide resin base material 1. Although there is no particular limitation for the solvent in which polyamic acid is soluble, a solvent having an amide group is preferred and, to be more specific, N-methylpyrrolidone and dimethylformamide may be exemplified.

When a solvent in which polyamic acid is soluble is contacted to the surface of the polyimide resin base material 1 as such, the solvent acts on the polyamic acid of the reformed portion 4 and the reformed portion 4 is partially dissolved from its surface whereby a concave part 3 (trench) in a groove shape is formed on the surface of the polyimide resin base material 1 as shown in FIG. 1D. Since this concave part 3 is formed by dissolving the reformed portion 4, polyamic acid having carboxylic acid forming a reformed portion 4 remains in the inner surface of the concave part 3. Incidentally, in FIG. 1D, a state where the reformed portion 4 is uniformly present along the concave part 3 is shown but that is non-limitative and the reformed portion 4 may be just present in a part of the concave part 3.

In the formation of the concave part 3 by contacting the solvent in which polyamic acid is soluble to the reformed portion 4 as mentioned above, depth of the concave part 3 is made deep by making the contacting time to the solvent in which polyamic acid is soluble long or by subjecting the polyimide resin base material 1 to a heating treatment. In order to contact the solvent in which polyamic acid is soluble to the resin base material 1, there are methods such as a method where the polyimide resin base material 1 is subjected to a dipping treatment in a solvent in which polyamic acid is soluble, and the treating temperature at that time is preferably 15 to 120° C., and the treating time is preferably 5 to 180 minutes. However, it is necessary to appropriately adjust the temperature and the time depending upon the thickness, etc. of the reformed portion 4 so that all of the reformed portions 4 are not removed. Depth of the concave part 3 is preferably within a range of 0.5 to 30 μm and, more preferably, within a range of 3 to 20 μm. It is preferred that, after the concave part 3 is formed as such, the surface of the polyimide resin base material 1 for example is washed to remove the decomposed product of the polyimide resin.

After the concave part 3 remaining the reformed portion 4 formed by the polyimide resin wherein carboxyl group is produced is formed on the site where inorganic thin film is formed on the surface of the polyimide resin base material 1 in the step (2) as mentioned above, the surface of the polyimide resin base material 1 is treated with a solution containing a metal ion in the step (3). With regard to the metal ion in the solution containing a metal ion, at least one selected from gold ion, silver ion, copper ion, platinum ammine complex, palladium ammine complex, tungsten ion, tantalum ion, titanium ion, tin ion, indium ion, cadmium ion, vanadium ion, chromium ion, manganese ion, aluminum ion, iron ion, cobalt ion, nickel ion and zinc ion may be listed. Among those metal ions, platinum ammine complex and palladium ammine complex are used in a state of alkaline solution, and metal ions other than them are used in a state of acid solution.

The surface of the polyimide resin base material 1 is treated with a solution containing a metal ion as such and the reformed portion 4 of the inner surface of the concave part 3 where carboxylic group is produced as above is contacted to a solution containing a metal ion whereby the metal ion (M²⁺) is coordinated to carboxyl group as shown below, for example,
—COO⁻ . . . M²⁺ . . . ⁻OOC—
whereby a metal salt of carboxyl group (metal salt of carboxylic acid) is able to be produced and, as shown in FIG. 1E, a reformed portion 5 containing metal ion is able to be formed at the place of the reformed portion 4 of the inner surface of the concave part 3. In the present invention, a “reformed portion containing metal ion” means a reformed portion having a metal salt of carboxyl group as mentioned above. At that time, it is possible to advance the coordinate exchange between metal ion and hydroxyl group, alkali metal or alkali earth metal in carboxyl group formed in the polyimide resin by increasing the degree of dissociation of hydroxyl group, alkali metal or alkali earth metal. For such a purpose, it is necessary to keep the polyimide resin base material 1 in an acidic state and, therefore, it is preferred in such a case to use an acidic solution containing a metal ion as a solution containing a metal ion.

Concentration of metal ion in the solution containing a metal ion has a close correlation to a ligand substitution reaction of hydroxyl group, alkali metal or alkali earth metal in carboxyl group formed in the polyimide resin with metal ion. Although it varies depending upon the metal ion species, concentration of metal ion is preferably 1 to 1,000 mM and, more preferably 10 to 500 mM. Low metal ion concentration is not preferred because time until the ligand substitution reaction reaches equilibrium becomes too long. Contacting time of the solution containing a metal ion to the surface of the polyimide resin base material 1 is preferably 10 to 600 seconds and, more preferably 30 to 420 seconds.

As mentioned above, in the step (3), a solution containing a metal ion is contacted to the reformed portion 4 of the inner surface of the concave part 3 of the polyimide resin base material 1 and a reformed portion 5 containing metal ion where metal salt of carboxyl group is formed and, after that, the surface of the polyimide resin base material 1 is preferably washed with water or alcohol to remove unnecessary metal ion. Then, in the step (4), metal salt in the reformed portion 5 containing metal ion is separated as metal or is separated as metal oxide or semiconductor whereby an inorganic thin film 6 comprising metal or an inorganic thin film 6 comprising metal oxide or semiconductor is able to be formed on the inner surface of the concave part 3 of the polyimide resin base material 1. In the step (4), a part of or the whole of the metal salts contained in the reformed portion 5 containing metal ion may be separated to be the inorganic thin film 6 depending on the thickness of the reformed portion 5 containing metal ion and the type of reducing agent, etc. For example, in the case that a part of the metal salt contained in the reformed portion 5 containing metal ion is separated as the inorganic thin film 6, as shown in FIG. 1F, the resulting inorganic thin film 6 is formed on the superficial portion of the reformed portion 5 containing metal ion on the inner surface of the concave part 3. On the other hand, in the case that the whole of the metal salt contained in the reformed portion 5 containing metal ion is separated as the inorganic thin film 6, the resulting inorganic thin film 6 is formed on the reformed portion 4, which does not contain metal salts.

In case the metal salt of the reformed portion 5 containing metal ionis separated as metal, it is able to be conducted by subjecting the metal salt to a reducing treatment. The reducing treatment is able to be carried out by, for example, treating the surface of the polyimide resin base material 1 with a solution containing a reducing agent or by subjecting the polyimide resin base material 1 to a heating treatment in an atmosphere of reducing gas or inert gas. Condition for the reduction varies depending upon the metal ion species and, in the case of treatment with a solution containing a reducing agent, it is possible to use a reducing agent such as sodium borohydride, phosphinic acid or a salt thereof or dimethylamine borane. In the case of treatment with a reducing gas, it is possible to use a reducing gas such as hydrogen and a mixed gas thereof or a mixed gas of borane with nitrogen, and in the case of treatment with inert gas, it is possible to use inert gas such as nitrogen gas or argon gas.

In the case where metal salt of the reformed portion 5 containing metal ion is separated as a metal oxide or a semiconductor, it is able to be carried out by treating the metal salt with activated gas. The condition for the treatment varies depending upon the metal ion species and a treatment is able to be conducted using oxygen and a mixed gas thereof, nitrogen and a mixed gas thereof, sulfur and a mixed gas thereof, etc. as the activated gas and the surface of the polyimide resin base material 1 is contacted td the activated gas.

Examples of the metal oxide include titanium oxide, tin oxide, indium oxide, vanadium oxide, manganese oxide, nickel oxide, aluminum oxide, iron oxide, cobalt oxide, zinc oxide, barium titanate, strontium titanate, compounded oxide of indium and tin, compounded oxide of nickel and iron and compounded oxide of cobalt and iron. When an inorganic thin film 6 comprising metal oxide as such is formed on the surface of the resin base material 1, the product is able to be used, for example, as condenser, transparent electrically conductive film, heat releasing agent, magnetic recording material, electrochromic element, sensor, catalyst and luminescent material.

Examples of the semiconductor include cadmium sulfide, cadmium telluride, cadmium selenide, silver sulfide, copper sulfide and indium phosphide. When an inorganic thin film 6 comprising such a semiconductor is formed on the surface of the polyimide resin base material 1, it is now able to be used, for example, as luminescent material, transistor and memory material.

Metal, metal oxide or semiconductor constituting the inorganic thin film 6 formed by the step (4) as mentioned above is preferably constituted from nano-particles having a particle size of 2 to 100 nm. Due to their very high surface energy, the inorganic nano-particles are easily aggregated and are present as an aggregate of inorganic nano-particles. At that time, although the degree varies depending upon the aforementioned metal ion concentration, reducing agent concentration, atmosphere temperature and activated gas concentration, a part of the inorganic particle aggregate is stabilized in the resin of the polyimide resin base material 1 or, in other words, a part of the inorganic nano-particle aggregate is in a state of being embedded in the surface layer of the polyimide resin and, by an anchor locking effect at that time, the polyimide resin base material 1 and the inorganic thin film 6 comprising the inorganic nano-particle aggregate are able to be strongly and tightly adhered. Especially in the common anchor locking effect achieved by chemical or physical roughening of the surface of the base material, the surface roughness is on a level of μm but, in the anchor locking effect of the inorganic nano-particles and the polyimide resin as in the present invention, an excellent close adhesion characteristic is able to be achieved even when the surface roughness is on a nanometer level and that is suitable for a wiring material for transmittance of electronic signal in a high frequency region.

As mentioned above, an inorganic thin film is able to formed on a polyimide resin base material 1 at the site to which an inorganic thin film is to be formed and, when the site to which the inorganic thin film is formed is set in a shape of a circuit pattern, a circuit pattern is able to be formed by the inorganic thin film 6 and the polyimide resin base material 1 is able to be utilized to an electronic part such as an electronic circuit substrate. Here, the inorganic thin film 6 is formed in the concave part 3 formed on the surface of the polyimide resin base material 1. Accordingly, the inorganic thin film 6 is hardly detached from the concave part 3 whereby the inorganic thin film 6 is able to be formed highly closely adhesive and, along the concave part 3, the inorganic thin film 6 is able to be formed highly precisely. Thus, in forming the circuit pattern by an inorganic thin film 6, it is able to be formed in high reliability for close adhesion and in high pattern precision.

Here, the inorganic thin film having a thickness about 10 to 500 nm can be formed by the aforementioned step (4). On the other hand, in an electronic circuit substrate, it is necessary that the film thickness of the circuit is about several μm level. Therefore, in using as an electronic circuit substrate, it is preferred that thickening is applied to the inorganic thin film 6 and film thickness of the circuit is made thick. Thus, after the step (4), non-electrolytic plating is conducted on the surface of the inorganic thin film 6 formed on the polyimide resin base material 1 whereby film thickness of the inorganic thin film 6 is able to be made thick by non-electrolytic plating in the step (5).

The non-electrolytic plating is able to be carried out, for example, by dipping the polyimide resin base material 1 in a non-electrolytic plating bath. At that time, a non-electrolytically plated film 7 is able to be separated on the surface of the inorganic thin film 6 using the aforementioned aggregate of nano-particles forming the inorganic thin film 6 as a nucleus for separation of the plating as shown in FIG. 1G. Thus, since the aggregate of the inorganic nano-particles has a very big specific surface area, it shows an excellent catalytic activity and, when it is used as a separating nucleus for separation of the non-electrolytically plated film 7, separation of plated film starts uniformly from many points whereby it is possible to give a non-electrolytically plated film 7 showing good close adhesion and electric characteristics. As a result of separation of the non-electrolytically plated film 7 on the surface of the inorganic thin film 6 using the inorganic nano-particle aggregate as a separating nucleus for the plating as such, the non-electrolytically plated film 7 is able to be formed selectively on the surface of the inorganic thin film 6 among the surfaces of the polyimide resin base material 1. The non-electrolytically plated film 7 is formed along the inner part of the concave part 3 where the inorganic thin film 6 is formed and, in forming a circuit by thickening of the inorganic thin film 6 with the non-electrolytically plated film 7, precision of circuit pattern is able to be maintained by the concave part 3 even after thickening of the film. Accordingly, thickness of the non-electrolytically plated film 7 is not more than the depth of the concave part 3 and, to be more specific, it is preferred to be 0.5 to 30 μm as mentioned above. When the inner area of the concave part 3 is completely filled with the non-electrolytically plated film 7, thickness of the non-electrolytically plated film 7 may be more than the depth of the concave part 3 and, in that case, it is preferred to be 0.5 to 31 μm. When thickness of the non-electrolytically plated film 7 is more than the depth of the concave part 3, it is preferred that the non-electrolytically plated film 7 exceeding the depth is removed by means of abrasion, for example, by a mechanical means such as grinding or a chemical means such as etching. Incidentally, in order to prevent the re-reforming of the polyimide resin base material 1, the non-electrolytically plating bath is preferred to be a neutral or weakly alkaline non-electrolytically plating bath.

### EXAMPLES

The present invention is now illustrated in greater detail with reference to Examples and Comparative Examples, but it should be understood that the present invention is not to be construed as being limited thereto.

### Example 1

Polyethylene glycol (10 parts by mass) was added as a thickener to 100 parts by mass of 10 M aqueous solution of KOH followed by stirring and dissolving to prepare an alkaline aqueous solution.

On the other hand, polyimide film (manufactured by Toray-DuPont; trade name: KAPTON 200-H) was dipped in an ethanol solution, subjected to an ultrasonic cleaning for 5 minutes and dried in an oven at 100° C. for 60 minutes to clean the surface of the polyimide film.

The aforementioned alkaline aqueous solution was filled in an ink cartridge of a print head, a circuit pattern of 50 μm linear width was drawn on the surface of the polyimide film using an ink jet printer of a piezo type, and the alkaline aqueous solution was applied on the polyimide film, and the polyimide film was allowed to stand at room temperature for 10 minutes. As a result, a reformed portion was formed in a shape of circuit pattern on the surface of the polyimide film (refer to FIG. 1C). After that, the polyimide film was dipped in an ethanol solution and subjected to an ultrasonic cleaning for 10 minutes.

Then the polyimide film was dipped for 30 minutes in a dimethylamine borane solution of 30° C. so that polyamic acid in the reformed portion was partially dissolved and removed, subjected to an ultrasonic cleaning in distilled water and dried at 100° C. for 1 hour. As a result, a concave part in a circuit pattern shape of 52 μm width and 4.5 μm depth was formed on the surface of the polyimide film (refer to FIG. 1D).

With regard to the polyimide film, it was checked whether the reformed portion remained on the inner surface of the concave part using a micro-ATR spectroscopic analyzer. As result, no band assigned to CO stretching vibration of imide ring near 1780 cm⁻¹ was noted while band assigned to CO stretching vibration of carboxyl group near 1740 cm⁻¹ was clearly noted whereby it was confirmed that the inner surface of the concave part was coated with a reformed portion comprising polyamic acid. It was further confirmed that, as a result of a cross-sectional TEM observation, thickness of this reformed portion was 0.5 μm.

Then, an aqueous solution of CuSO₄ of 100 mM concentration was used as an acidic solution containing a metal ion, the polyimide film was dipped in the aqueous solution for 5 minutes, Cu ion was selectively coordinated to the reformed portion formed near the inner surface of the concave part and a reformed portion containing metal ion was formed (refer to FIG. 1E). After that, an excessive CuSO₄ was removed by distilled water.

Then an aqueous solution of NaBH₄ of 5 mM concentration was used as a reducing solution and the aforementioned polyimide film where the surface was reformed was dipped in the aqueous solution for 5 minutes and washed with distilled water whereby separation of a thin copper film was confirmed on the inner surface of the concave part (refer to FIG. 1F). Thickness of the thin copper film was 50 nm and electric resistance of the thin copper film was 5×10⁻³ Ωcm and a circuit pattern having the same shape as the concave part was able to be formed.

After that, the polyimide film was dipped for 3 hours in a neutral non-electrolytic copper plating bath being adjusted to 50° C. and having the following bath composition.

| CuCl₂ | 0.05 M |
|---|---|
| Ethylenediamine | 0.60 M |
| Co(NO₃)₂ | 0.15 M |
| Ascorbic acid | 0.01 M |
| 2,2′-Dipyridyl | 20 ppm |
| pH | 6.75 |

In the inner area of the concave part, the non-electrolytically plated copper was separated on the thin copper film to give a uniform copper plated film having a thickness of 4 μm. Electric resistance of the copper plated film was 3×10⁻⁵ Ωcm and a circuit of electronic circuit substrate was able to be formed from the aforementioned thin copper film and this copper plated film (refer to FIG. 1G).

### Example 2

An aqueous solution of KOH of 5 M concentration was enclosed in capsules of a styrene-acrylate type resin using a water-in-oil-in-water method to prepare microcapsules of 3 μm particle size.

After applying the metal complex containing an azo type to the surface of the microcapsules, a circuit pattern of 50 μm line width was transcribed by an electronic photographic method on the surface of the polyimide film where the surface was cleaned in the same manner as in Example 1 whereby the microcapsules were printed followed by subjecting to a heating treatment for 30 minutes in an oven kept at 60° C. As a result, a reformed portion was formed on the surface of the polyimide film in a shape of circuit pattern (refer to FIG. 1C). After that, the polyimide film was dipped in an ethanol solution and ultrasonic cleaning was conducted for 10 minutes.

Then, the polyimide film was dipped for 30 minutes in an N-methylpyrrolidone solution of 45° C. to partially dissolve and remove the polyamic acid in the reformed portion, subjected to an ultrasonic cleaning in distilled water and dried at 60° C. for 30 minutes. As a result, a concave part in a circuit pattern shape of 53 μm width and 16 μm depth was formed on the surface of the polyimide film (refer to FIG. 1D).

With regard to the polyimide film, it was checked whether the reformed portion remained on the inner surface of the concave part using a micro-ATR spectroscopic analyzer. As result, no band assigned to CO stretching vibration of imide ring near 1780 cm⁻¹ was noted while band assigned to CO stretching vibration of carboxyl group near 1740 cm⁻¹ was clearly noted whereby it was confirmed that the inner surface of the concave part was coated with a reformed portion comprising polyamic acid. It was further confirmed that, as a result of a cross-sectional TEM observation, thickness of this reformed portion was 2 μm.

Then, an aqueous solution of AgNO₃ of 100 mM concentration was used as an acidic solution containing a metal ion, the polyimide film was dipped in the aqueous solution for 5 minutes, Ag ion was selectively coordinated to the reformed portion formed near the inner surface of the concave part and a reformed portion containing metal ion was formed (refer to FIG. 1E). After that, an excessive AgNO₃ was removed by distilled water.

Then the aforementioned polyimide film where the surface was reformed was subjected to a reduction treatment for 30 minutes in 50% hydrogen stream (N₂ balance) of 200° C. using hydrogen as a reducing gas whereby separation of thin silver film was confirmed on the inner surface of the concave part (refer to FIG. 1F). Thickness of the thin silver film was 300 nm and electric resistance of the thin silver film was 5×10⁻³ Ωcm and a circuit pattern having the same shape as the concave part was able to be formed.

After that, the polyimide film was dipped for 3 hours in a neutral non-electrolytic nickel plating bath being adjusted to 75° C. and having the following bath composition.

| NiSO₄ | 0.1 M |
|---|---|
| CH₃COOH | 1.0 M |
| NaH₂PO₂ | 0.2 M |
| pH | 4.5 |

In the inner area of the concave part, the non-electrolytically plated nickel was separated on the thin silver film to give a uniform nickel plated film having a thickness of 4 μm. Electric resistance of the nickel plated film was 3×10⁻⁵ Ωcm and a circuit of electronic circuit substrate was able to be formed from the aforementioned thin silver film and this nickel plated film (refer to FIG. 1G).

### Example 3

Ethyl cellulose (30 patrs by mass) was added as a thickener to 1 M aqueous solution of NaOH followed by stirring and dissolving to prepare an alkaline aqueous solution.

The aforementioned alkaline aqueous solution was filled in an ink cartridge of a print head, a circuit pattern of 20 μm linear width was drawn using an ink jet printer of a piezo type on the surface of the polyimide film where the surface was cleaned by the same manner as in Example 1 and allowed to stand at 50° C. for 20 minutes. As a result, a reformed portion was formed in a shape of circuit pattern on the surface of the polyimide film (refer to FIG. 1C). After that, the polyimide film was dipped in a 1-propanol solution, subjected to an ultrasonic cleaning for 10 minutes and dried at 100° C. for 30 minutes.

Then the polyimide film was dipped for 20 minutes in an N-methylpyrrolidone solution of 40° C. so that polyamic acid in the reformed portion was partially dissolved and removed, subjected to an ultrasonic cleaning in distilled water and dried at 100° C. for 30 minutes. As a result, a concave part in a circuit pattern shape of 21 μm width and 8 μm depth was formed on the surface of the polyimide film (refer to FIG. 1D).

With regard to the polyimide film, it was checked whether the reformed portion remained on the inner surface of the concave part using a micro-ATR spectroscopic analyzer. As result, no band assigned to CO stretching vibration of imide ring near 1780 cm⁻¹ was noted while band assigned to CO stretching vibration of carboxyl group near 1740 cm⁻¹ was clearly noted whereby it was confirmed that the inner surface of the concave part was coated with a reformed portion comprising polyamic acid. It was further confirmed that, as a result of a cross-sectional TEM observation, thickness of this reformed portion was 2 μm.

Then, aqueous solution of NiSO₄ of 50 mM concentration was used as an acidic solution containing a metal ion, the aforementioned polyimide film where the surface was reformed was dipped in the aqueous solution for 5 minutes, Ni ion was selectively coordinated to the reformed portion formed near the inner surface of the concave part and a reformed portion containing metal ion was formed (refer to FIG. 1E). After that, an excessive NiSO₄ was removed by distilled water.

Then an aqueous solution of hydrazine of 150 mM concentration was used as a reducing solution and the polyimide film was dipped in the aqueous solution for 10 minutes and washed with distilled water whereby separation of a thin nickel film was confirmed on the inner surface of the concave part (refer to FIG. 1F). Thickness of the thin nickel film was 120 nm and electric resistance of the thin nickel film was 1.5×10⁻² Ωcm and a circuit pattern having the same shape as the concave part was able to be formed.

The polyimide film where the thin nickel film pattern was formed as such was subjected to the same treatment as in Example 2 and used for formation of circuit for an electronic circuit substrate.

### Example 4

Eethyl cellulose (30 parts by mass) was added as a thickener to 100 parts by mass of 5 M aqueous solution of NaOH followed by stirring and dissolving to prepare an alkaline aqueous solution.

The aforementioned alkaline aqueous solution was filled in an ink cartridge of a print head, a circuit pattern of 20 μm linear width was drawn using an ink jet printer of a piezo type on the surface of the polyimide film and allowed to stand at 30° C. for 40 minutes. As a result, a reformed portion was formed in a shape of circuit pattern on the surface of the polyimide film (refer to FIG. 1C). After that, the polyimide film was dipped in a methanol solution, subjected to an ultrasonic cleaning for 10 minutes and dried at 40° C. for 10 minutes.

Then the polyimide film was dipped for 1 hour in a dimethylformamide solution of 28° C. so that polyamic acid in the reformed portion was partially dissolved and removed, subjected to an ultrasonic cleaning in distilled water for 10 minutes and dried at 80° C. for 30 minutes. As a result, a concave part in a circuit pattern shape of 21 μm width and 10 μm depth was formed on the surface of the polyimide film (refer to FIG. 1D).

With regard to the polyimide film, it was checked whether the reformed portion remained on the inner surface of the concave part using a micro-ATR spectroscopic analyzer. As result, no band assigned to CO stretching vibration of imide ring near 1780 cm⁻¹ was noted while band assigned to CO stretching vibration of carboxyl group near 1740 cm⁻¹ was clearly noted whereby it was confirmed that the inner surface of the concave was coated with a reformed portion comprising polyamic acid. It was further confirmed that, as a result of a cross-sectional TEM observation, thickness of this reformed portion was 5 μm.

Then, aqueous solution of CuSO₄ of 50 mM concentration was used as an acidic solution containing a metal ion, the aforementioned polyimide film where the surface was reformed was dipped in the aqueous solution for 5 minutes, Cu ion was selectively coordinated to the reformed portion formed near the inner surface of the concave part and a reformed portion containing metal ion was formed (refer to FIG. 1E). After that, an excessive CuSO₄ was removed by distilled water.

Then an aqueous solution of dimethylamine borane of 100 mM concentration was used as a reducing solution and the polyimide film was dipped in the aqueous solution for 10 minutes and washed with distilled water whereby separation of a thin copper film was confirmed on the inner surface of the concave part (refer to FIG. 1F). Thickness of the thin copper film was 500 nm and electric resistance of the thin copper film was 9×10⁻³ Ωcm and a circuit pattern having the same shape as the concave part was able to be formed.

The polyimide film where the thin copper film pattern was formed as such was subjected to the same treatment as in Example 1 and used for formation of circuit for an electronic circuit substrate.

### Example 5

Ethyl cellulose (30 parts by mass) was added as a thickener to 100 parts by mass of 3 M aqueous solution of Mg(OH)₂ followed by stirring and dissolving to prepare an alkaline aqueous solution.

The aforementioned alkaline aqueous solution was filled in an ink cartridge of a print head, a circuit pattern of 30 μm linear width was drawn using an ink jet printer of a piezo type on the surface of the polyimide film and allowed to stand at room temperature for 20 minutes. As a result, a reformed portion was formed in a shape of circuit pattern on the surface of the polyimide film (refer to FIG. 1C). After that, the polyimide film was dipped in a 1-propanol solution, subjected to an ultrasonic cleaning for 10 minutes and dried at 100° C. for 30 minutes.

Then the polyimide film was dipped for 5 minutes in an N-methylpyrrolidone solution of 25° C. so that polyamic acid in the reformed portion was partially dissolved and removed, subjected to an ultrasonic cleaning in distilled water for 10 minutes and dried at 80° C. for 30 minutes. As a result, a concave part in a circuit pattern shape of 20 μm width and 3 μm depth was formed on the surface of the polyimide film (refer to FIG. 1D).

With regard to the polyimide film, it was checked whether the reformed portion remained on the inner surface of the concave part using a micro-ATR spectroscopic analyzer. As result, no band assigned to CO stretching vibration of imide ring near 1780 cm⁻¹ was noted while band assigned to CO stretching vibration of carboxyl group near 1740 cm⁻¹ was clearly noted whereby it was confirmed that the inner surface of the concave part was coated with a reformed portion comprising polyamic acid. It was further confirmed that, as a result of a cross-sectional TEM observation, thickness of this reformed portion was 1 μm.

Then, aqueous solution of CuSO₄ of 100 mM concentration was used as an acidic solution containing a metal ion, the aforementioned polyimide film where the surface was reformed was dipped in the aqueous solution for 5 minutes, Cu ion was selectively coordinated to the reformed portion formed near the inner surface of the concave part and a reformed portion containing metal ion was formed (refer to FIG. 1E). After that, an excessive CuSO₄ was removed by distilled water.

Then an aqueous solution of NaBH₄ of 5 mM concentration was used as a reducing solution and the polyimide film was dipped in the aqueous solution for 5 minutes and washed with distilled water whereby separation of a thin copper film was confirmed on the inner surface of the concave part (refer to FIG. 1F). Thickness of the thin copper film was 90 nm and electric resistance of the thin copper film was 5×10⁻³ Ωcm and a circuit pattern having the same shape as the concave part was able to be formed.

The polyimide film where the thin copper film pattern was formed as such was subjected to the same treatment as in Example 1 and used for formation of circuit for an electronic circuit substrate.

### Example 6

Glycerol (50 parts by mass) was added as a thickener to 100 parts by mass of 5 M aqueous solution of KOH followed by stirring and dissolving to prepare an alkaline aqueous solution.

The aforementioned alkaline aqueous solution was filled in an ink cartridge of a print head, a circuit pattern of 15 μm linear width was drawn using an ink jet printer of a thermal type on the surface of the polyimide film where the surface was cleaned by the same manner as in Example 1 and allowed to stand at 48° C. for 30 minutes. As a result, a reformed portion was formed in a shape of circuit pattern on the surface of the polyimide film (refer to FIG. 1C). After that, the polyimide film was dipped in a 1-propanol solution, subjected to an ultrasonic cleaning for 10 minutes and dried at 100° C. for 30 minutes.

Then the polyimide film was dipped for 30 minutes in a dimethylamine borane of 45° C. so that polyamic acid in the reformed portion was partially dissolved and removed, subjected to an ultrasonic cleaning in distilled water for 10 minutes and dried at 80° C. for 30 minutes. As a result, a concave part in a circuit pattern shape of 16 μm width and 12 μm depth was formed on the surface of the polyimide film (refer to FIG. 1D).

With regard to the polyimide film, it was checked whether the reformed portion remained on the inner surface of the concave part using a micro-ATR spectroscopic analyzer. As result, no band assigned to CO stretching vibration of imide ring near 1780 cm⁻¹ was noted while band assigned to CO stretching vibration of carboxyl group near 1740 cm⁻¹ was clearly noted whereby it was confirmed that the inner surface of the concave part was coated with a reformed portion comprising polyamic acid. It was further confirmed that, as a result of a cross-sectional TEM observation, thickness of this reformed portion was 3 μm.

Then, an aqueous solution of indium sulfate of 0.1 M concentration and an aqueous solution of tin sulfate of 0.1 M concentration were mixed to prepare an aqueous solution containing a metal ions where the molar ratio of indium ion to tin ion in terms of In/Sn is 15/85, the aforementioned polyimide film where the surface was reformed was dipped in the aqueous solution containing a metal ions for 20 minutes, indium ion and tin ion were selectively coordinated to the reformed portion at the inner surface of the concave part and a reformed portion containing metal ions was formed (refer to FIG. 1E). After that, excessive metal ions were removed by distilled water.

Then the polyimide film was subjected to a heating treatment at 350° C. for 3 hours in a hydrogen atmosphere to give an aggregate of nano-particles comprising an indium-tin alloy. At that time, film thickness of the nano-particle aggregate was 50 nm. After that, the polyimide film was subjected to a heating treatment in an atmosphere of air under the condition of 300° C. for 6 hours so that the indium-tin alloy was made to react with oxygen to form a thin ITO film on the inner surface of the concave part (refer to FIG. 1F). Sheet resistance of the thin ITO film was 0.7 Ω/□.

### Example 7

Polyvinylpyrrolidone (30 parts by mass) and 20 parts by mass of glycerol were added as thickeners to 100 parts by mass of 5 M aqueous solution of ethylenediamine followed by stirring and dissolving to prepare an alkaline aqueous solution.

The aforementioned alkaline aqueous solution was filled in an ink cartridge of a print head, a circuit pattern of 10 μm linear width was drawn using an ink jet printer of a thermal type on the surface of the polyimide film where the surface was cleaned by the same manner as in Example 1 and allowed to stand at 50° C. for 20 minutes. As a result, a reformed portion was formed in a shape of circuit pattern on the surface of the polyimide film (refer to FIG. 1C). After that, the polyimide film was dipped in an ethanol solution and subjected to an ultrasonic cleaning for 10 minutes.

Then the polyimide film was dipped for 30 minutes in an N-methylpyrrolidone solution of 40° C. so that polyamic acid in the reformed portion was partially dissolved and removed, subjected to an ultrasonic cleaning in distilled water for 10 minutes and dried at 80° C. for 30 minutes. As a result, a concave part in a circuit pattern shape of 12 μm width and 8 μm depth was formed on the surface of the polyimide film (refer to FIG. 1D).

With regard to the polyimide film, it was checked whether the reformed portion remained on the inner surface of the concave part using a micro-ATR spectroscopic analyzer. As result, no band assigned to CO stretching vibration of imide ring near 1780 cm⁻¹ was noted while band assigned to CO stretching vibration of carboxyl group near 1740 cm⁻¹ was clearly noted whereby it was confirmed that the inner surface of the concave part was coated with a reformed portion comprising polyamic acid. It was further confirmed that, as a result of a cross-sectional TEM observation, thickness of this reformed portion was 3 μm.

Then, the aforementioned polyimide film where the surface was reformed was dipped for 3 minutes in an aqueous solution containing a metal ion comprising an aqueous solution of cadmium nitrate of 50 mM concentration so that cadmium ion (II) was coordinated to the reformed portion on the inner surface of the concave part whereby a reformed portion containing metal ion was formed (refer to FIG. 1E). After that, an excessive cadmium nitrate was removed by distilled water.

Then an aqueous solution comprising a composition of sodium sulfide of 100 ppm concentration, disodium hydrogen phosphate of 5 mM concentration and potassium dihydrogen phosphate of 5 mM concentration was kept at 30° C. and the polyimide film was dipped for 20 minutes therein to conduct a sulfuration treatment to give an aggregate of nano-particles of cadmium sulfide. Then the treatments as from the aforementioned treatment with the alkaline aqueous solution were repeated for ten times to increase the concentration of cadmium sulfide nano-particle aggregate.

After that, a heating treatment under the condition of 300° C. for 5 hours in an atmosphere of air was conducted whereby thin film of cadmium sulfide was formed on the inner surface of the concave part (refer to FIG. 1F). Film thickness of the thin film of cadmium sulfide was 2.3 μm.

### Comparative Example 1

Polyvinylpyrrolidone (30 parts by mass) and 20 parts by mass of glycerol were added as thickeners to 100 parts by mass of an aqueous solution of ethylenediamine in 5 M concentration followed by stirring and dissolving to prepare an alkaline aqueous solution.

The aforementioned alkaline aqueous solution was filled in an ink cartridge of a print head, a circuit pattern of 20 μm linear width was drawn using an ink jet printer of a piezo type on the surface of the polyimide film where the surface was cleaned by the same manner as in Example 1 and allowed to stand at 50° C. for 30 minutes. As a result, a reformed portion was formed in a shape of circuit pattern on the surface of the polyimide film. After that, the polyimide film was dipped in a 1-propanol solution, subjected to an ultrasonic cleaning for 10 minutes and dried at 100° C. for 30 minutes.

Then the polyimide film was dipped for 3 hours in an N-methylpyrrolidone solution of 35° C. so that polyamic acid in the reformed portion was dissolved and removed, subjected to an ultrasonic cleaning in distilled water for 10 minutes and dried at 80° C. for 30 minutes. As a result, a gutter-shaped concave part in a circuit pattern shape of 21 μm width and 15 μm depth was formed on the surface of the polyimide film.

With regard to the polyimide film, it was checked whether the reformed portion remained on the inner surface of the concave part using a micro-ATR spectroscopic analyzer. As result, band assigned to CO stretching vibration of imide ring near 1780 cm⁻¹ was noted while no band assigned to CO stretching vibration of carboxyl group near 1740 cm⁻¹ was noted whereby it was confirmed that polyamic acid did not remain on the inner surface of the concave part and that no reformed portion remained. As a result of a cross-sectional TEM observation, no reformed portion was confirmed as well.

Then, aqueous solution of CuSO₄ of 50 mM concentration was used as an acidic solution containing a metal ion, the aforementioned polyimide film was dipped in the aqueous solution for 5 minutes and, after that, an excessive CuSO₄ was removed.

Then an aqueous solution of dimethylamine borane in 100 mM concentration was used as a reducing solution and the polyimide film was dipped in the aqueous solution for 10 minutes and washed with distilled water. No separation of thin copper film was noted on the inner surface of the concave part and the thin copper film pattern was not able to be formed.

### Comparative Example 2

Polyethylene glycol (10 parts by mass) was added as a thickener to 100 parts by mass of an aqueous solution of KOH in 10 M concentration followed by stirring and dissolving to prepare an alkaline aqueous solution.

The aforementioned alkaline aqueous solution was filled in an ink cartridge of a print head, a circuit pattern of 20 μm linear width was drawn using an ink jet printer of a piezo type on the surface of the polyimide film where the surface was cleaned by the same manner as in Example 1 and allowed to stand at room temperature for 20 minutes. As a result, a reformed portion was formed in a shape of circuit pattern on the surface of the polyimide film. After that, the polyimide film was dipped in a 1-propanol solution, subjected to an ultrasonic cleaning for 10 minutes and dried at 100° C. for 30 minutes.

Then the polyimide film was dipped for 3 hours in an acetone solution, subjected to an ultrasonic cleaning in distilled water for 10 minutes and dried at 80° C. for 30 minutes. As a result, it was unable to be confirmed that a gutter-shaped concave part was formed on the surface of the polyimide film.

As described above, the present invention is widely applicable for the manufacture of electronic parts and mechanical parts, particularly for the manufacture of flexible circuit plate, flex rigid circuit plate and circuit plate such as carrier for TAB.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2004-355761 filed on Dec. 8, 2004, and the contents thereof are incorporated herein by reference.

What is claimed is:

1. A method for forming an inorganic thin film on a polyimide resin, which comprises:
(1) a step of applying an alkaline aqueous solution on a polyimide resin at the site where an inorganic thin film is formed to cleave an imide ring of the polyimide resin so as to produce a carboxyl group and to reform the polyimide resin to a polyamic acid whereby a reformed portion comprising the polyamic acid having the carboxyl group is formed;
(2) a step of contacting a solvent in which the polyamic acid is soluble to the reformed portion to remove a part of the reformed portion so as to form a concave part;
(3) a step of contacting a solution containing a metal ion to the reformed portion near the concave part so as to produce a metal salt of the carboxyl group; and
(4) a step of separating the metal salt as a metal, a metal oxide or a semiconductor on the surface of the polyimide resin so as to form the inorganic thin film.

2. The method for forming an inorganic thin film on a polyimide resin according to claim 1,
wherein the solvent in which the polyamic acid is soluble is a solvent having an amide group.

3. The method for forming an inorganic thin film on a polyimide resin according to claim 1,
wherein, in the step (1), the alkaline aqueous solution is applied on a polyimide resin at the site where an inorganic thin film is formed by an ink jet method.

4. The method for forming an inorganic thin film on a polyimide resin according to claim 1,
wherein, in the step (1), the alkaline aqueous solution is applied on a polyimide resin at the site where an inorganic thin film is formed by a transfer method.

5. The method for forming an inorganic thin film on a polyimide resin according to claim 1,
wherein, in the step (1), an alkali-resistant protective layer is formed on a polyimide resin at the part other than the site where an inorganic thin film is formed before applying the alkaline aqueous solution on the polyimide resin.

6. The method for forming an inorganic thin film on a polyimide resin according to claim 1,
wherein, in the step (4), the metal salt is subjected to a reducing treatment to be separated as a metal on a surface of the polyimide resin so as to form a metal thin film.

7. The method for forming an inorganic thin film on a polyimide resin according to claim 1,
wherein, in the step (4), the metal salt is reacted with an activated gas to be separated as a metal oxide or a semiconductor on a surface of the polyimide resin so as to form a metal oxide thin film or a semiconductor thin film.

8. The method for forming an inorganic thin film on a polyimide resin according to claim 1,
wherein, in the step (4), the inorganic thin film comprises an aggregate of inorganic nano-particles.

9. The method for forming an inorganic thin film on a polyimide resin according to claim 8,
wherein, in the step (4), a part of the aggregate of inorganic nano-particles is embedded in the polyimide resin.

10. The method for forming an inorganic thin film on a polyimide resin according to claim 1, which further comprises, after the step (4),
(5) a step of subjecting to a non-electrolytic plating on the surface of the polyimide resin on which the inorganic thin film is separated.

11. The method for forming an inorganic thin film on a polyimide resin according to claim 8, which further comprises, after the step (4),
(5) a step of subjecting to a non-electrolytic plating on the surface of the polyimide resin on which the inorganic thin film is separated.

12. The method for forming an inorganic thin film on a polyimide resin according to claim 11,
wherein, in the step (5), the non-electrolytic plating is carried out by using the aggregate of the inorganic nano-particles as a nucleus for separation of plating.

13. The method for forming an inorganic thin film on a polyimide resin according to claim 1,
wherein the inorganic thin film has a shape of a circuit pattern.

14. A method for producing a polyimide resin having a reformed surface for forming an inorganic thin film, which comprises:
applying an alkaline aqueous solution on a part of a polyimide resin to cleave an imide ring of the polyimide resin so as to produce a carboxyl group and to reform the polyimide resin to a polyamic acid whereby a reformed portion comprising the polyamic acid having the carboxyl group is formed; and
contacting a solvent in which the polyamic acid is soluble to the reformed portion to remove a part of the reformed portion so as to form a concave part in such a state that a part of the reformed portion remains.
